(19) United States
(12) Patent Application Publication
(10) Pub. No.: US 2009/0188445 A1
(43) Pub. Date: Jul. 30, 2009

(54) Equine cast cover and protective device

(76) Inventor: Joan Viehouser Jacobsen, Sisters, OR (US)

Correspondence Address: Thomas M. Spear, Jr., P.O. Box 1274, Bend, OR, 97709-1274, US

(21) Appl. No.: 12/321,494

(22) Filed: Jan. 21, 2009

Related U.S. Application Data
(60) Provisional application No. 61/062,447, filed on Jan. 24, 2008.

(51) Int. Cl. A01K 13/00

(52) U.S. Cl. 119/850

(57) ABSTRACT

A protective cover for an animal's extremity, that: is soft or comfortable to the animals hoof, foot or pads; is adjustable for fit; can protect or cover the length of the animal's leg; is durable; and easy to put on and take off; is easily cleaned and re-useable; and can reduce the wear or tear upon a bandage, splint or cast reducing the need for re-bandaging, splinting or casting. The device employs a stable and moldable base with an open ended piece of durable material, called a shell, which is fashioned into a tapered tube that is opened up on the side so as to allow the animal's foot or hoof to be inserted. The tapered tube wraps and closes around the horse's lower leg by use of several elastic straps sewn horizontally onto the exterior of the tapered tube material. The sizing of the protective covering allows the tube to be closed over most sized bandages, wraps or casts placed upon the injured animal and means for closing the tube from dirt or other items that might damage or degrade a bandage, wrap, splint or cast placed upon the animal's leg. Inserted or attached to the top of the moldable base is a soft neoprene pad that is resilient and provides a barrier from the ground with bottom of the horse's hoof This barrier is waterproof yet breathable and beneficial for the horse in that the horse's hoof is protected from contact with the ground yet the pliable nature allows for a more even distribution of weight to be applied on the animal's limbs.

### CROSS REFERENCE TO RELATED APPLICATION

Applicant claims the benefit of previously filed Provisional Patent Application 61/062,447.

### BACKGROUND OF THE INVENTION

The present invention relates to the need for a protective device on an animal's extremity or limb when the animal has suffered an injury or has a medical condition and there is a need to protect the injury, medical condition, bandage, wrap or cast that has been placed on the animal's limb. The particulars of this device were created for an equine; however the device has application for a variety of animals that need a device to cover or protect a hoof, paw, foot, or limb with a medical condition, injury, bandage, wrap, splint or cast to be placed upon the animal's extremity. The primary discussion for the background and detailed description involves the device being used on a horse or equine animal, other similar embodiments are easily adapted for other animal use and made in the claims.

A number of devices exist for covering a horse's hoof or lower extremity. Typically these devices are designed for protecting the hoof and lower extremities from various assortments of injury or diseases associated with the hoof or lower extremity of the horse's leg. There are numerous designs for replacing a horseshoe that involve covering the hoof and lower leg of a horse. The present invention provides for a device that is designed and constructed to cover the leg of a horse that has an injury requiring a bandage, wrap, splint or cast to the leg. Other devices that have been used to cover an equine's hoof or leg typically do so for reasons other than for the protection of an injury, bandage, wrap, splint or cast.

For example, in U.S. Pat. No. 6,868,656, Mar. 22, 2004, which relates to a “comfort management system for equine” in the description and claims for the device, the invention details a boot or shoe configuration for comfort to the equine's hoof The device provides a means for interchanging the sole of the hoof protector and allows for the limited protection of the horses hoof While the device is a practical improvement for treating horses with hoof or coronet ailment, the design is limited in that it is not practical for injuries on the horse's fetlock, ankle or other regions of the horse's leg.

In U.S. Pat. No. 6,931,767, Aug. 23, 2005, a device for covering a hoofed animal foot is comprised of a molding that fits around the animal's foot. This device employs an elastically stretchable mold with an opening for slipping the device on the animals hoof/leg. This device is limited from the present invention in that this invention is used once and then discarded and the length of time for using, while variable, is a function of the environment in which the animal is stalled or able to roam. This becomes inconvenient to animal owners who require a device that is durable and resistant to the normal environmental damage associated with roaming animals, which the present invention is able to do. Additionally, unlike the '767 patent, the present invention is designed to be placed upon the hoof and leg of the horse and be adjustable so as to fit various sizes of bandages, wraps, splints or casts placed upon the animals leg or hoof.

There are number of patents for replacing a horseshoe or covering a hoof in a manner that protects the hoof, as covered in the '656 patent. Including U.S. Pat. No. 4,981,010, issued Jan. 1, 1991. There is a long list of patents that provide means for protecting the bottom of the hoof, prevent disease of the hoof, or promote good health for the hoof Including U.S. Pat. No. 5,174,382, U.S. Pat. No. 4,736,800, U.S. Pat. No. 5,715,661 to list a few. The present invention does not replace a horseshoe and is able to fit over a shoe or a plain hoof The design of the present invention allows for a stable platform on which the animal is able to stand and walk or trot.

One device used for protecting the lower portion of the horse's leg, including the hoof and pastern region is U.S. Pat. No. 7,174,858. This device is a low profile protective device that covers the horse's hoof and pastern area. The device does not address protection for the animal's upper leg, or the need for a protective device to be adjustable to cover a bandage, wrap or cast.

While there are a quite a few devices for, enhancing the comfort of a horse's hoof, replacing horseshoes, or covering the leg and hoof of a horse, there does not appear to be a device that provides a covering to a horses hoof and leg region that is easy to put on, comfortable for the animal to wear, rugged and durable for an animal that roams in a field, and adjustable for various sizes of bandages, wraps, splints or casts placed upon the horse's leg or hoof.

### BRIEF SUMMARY OF THE INVENTION

A protective cover for a horse's limb, that: is soft or comfortable to the horses hoof; is adjustable for fit; can protect or cover the length of the horse's limb; is durable; and easy to put on and take off; is easily cleaned and re-useable; and can reduce the wear or tear upon a bandage, splint or cast reducing the need for re-bandaging, splinting or casting. The device employs a stable and moldable sole and a trapezoidal shaped piece of durable material, called a shell, which is fashioned into a tapered tube that is opened up on the side so as to allow the animal's foot or hoof to be inserted. The tapered tube wraps and closes around the horse's lower limb by use of several elastic straps sewn horizontally onto the exterior of the tapered tube material.

The trapezoidal shaped shell has an upper end that is opened and a lower end that is attached to the moldable sole around the edges with the sides of the lowest part of the shell overlapping around the edge to minimize and prevent moisture, dirt and foreign objects from entering into the interior of the tapered tube.

The moldable sole is typically constructed from a circular piece of leather with a bottom side being treated to prevent or limit moisture from penetrating inside the protective cover. The edges of the moldable base are turned up into an edge to allow the horse's hoof to sit within the moldable sole for improved stability. On a top side of the moldable sole, inside the upturned edges, is placed a soft polychloropene pad, like neoprene. Neoprene, a fairly tough and durable material, is used to provide an additional moisture barrier from the ground with the bottom of the horse's hoof This barrier is waterproof yet breathable and beneficial for the horse in that the horse's hoof is protected from contact with the ground yet the pliable nature of the neoprene allows for a more even distribution of weight to be applied on the animal's limbs.

In one embodiment, a small piece of elastic material, called a flap, is placed at the junction of the base where the edges of the lower shell material are joined to the base. This flap provides an additional barrier for dirt and moisture from entering the shell.

By sizing the shell and sole the shell is able to be closed over most sized bandages, wraps or casts placed upon the injured horse's limb and hoof with additional means for closing the tube from dirt or other items that might damage or degrade a bandage, wrap, splint or cast placed upon the horse's limb. The device is created to permit a user to adjust the device on the horse's limb to obtain the most comfortable fit—regardless of the type of bandage, wrap, splint or cast that is worn by the horse. During the course of treatment, for an injury to the extremity of a horse, the animal may have to wear a series of protective bandages, wraps, splint or cast, each having a different size and shape, the present invention provides the user the ability to adjust the tapered tube or shell so as to provide a better fit and a better means for protecting the horse's leg and any bandage, wrap, splint or cast from being damaged or from being exposed to the elements; rain, dirt, etc.., which could cause additional harm to the injury or degrade the bandage, wrap, splint or cast upon the horse's limb.

The upper portion of the device is called a shell that is comprised of a trapezoidal piece of flexible durable material, like Kevlar®, that is affixed to a sole such that the equine's hoof can be placed onto the top of the sole and the angled sides of the trapezoidal shaped piece of material can then be wrapped together to enclose the hoof and limb in a tubular shaped like shield. The two sides that are wrapped together can be fastened together by various means. In the preferred embodiment, elastic strips of material are placed on the outside of the shell, with hook and loop material attached to the ends, and when the angular sides of the shell are brought together around the horse's limb, the user can secure the shell in place by securing the ends of the strap together. The limb and any bandage, wrap or cast are covered and protected from the surrounding environment to minimize the degradation of the injury, bandage, splint, cast or dressing.

It is a further objective of this invention to: provide a protective covering that is easily put on and taken off; that the device can be reused and refurbished; that the device is able to be cleaned or washed and then re-applied or reused; that the device can be made in a cost efficient manner, and to provide a protective covering that allows the duration of any bandage, wrap or cast to be extended due to the high cost of bandaging, wrapping and especially casting an animal's leg.

### BRIEF DESCRIPTION OF THE SEVERAL VIEWS OF THE DRAWINGS

FIG. 1 is a perspective view of the protective device for covering a horse's hoof and leg with the tapered tube being opened and the elastic bands unsecured—ready to be placed on a horse's foot.

FIG. 2 is an angled side view of the sole.

FIG. 3 is an exploded angled side view of the sole.

### DETAILED DESCRIPTION OF THE INVENTION

The Figures and the description of the device and its operation include those components and processes necessary for understanding how the protective device functions and does not include every possible configuration or operation that could be deployed and would be readily understood by those skilled in the art.

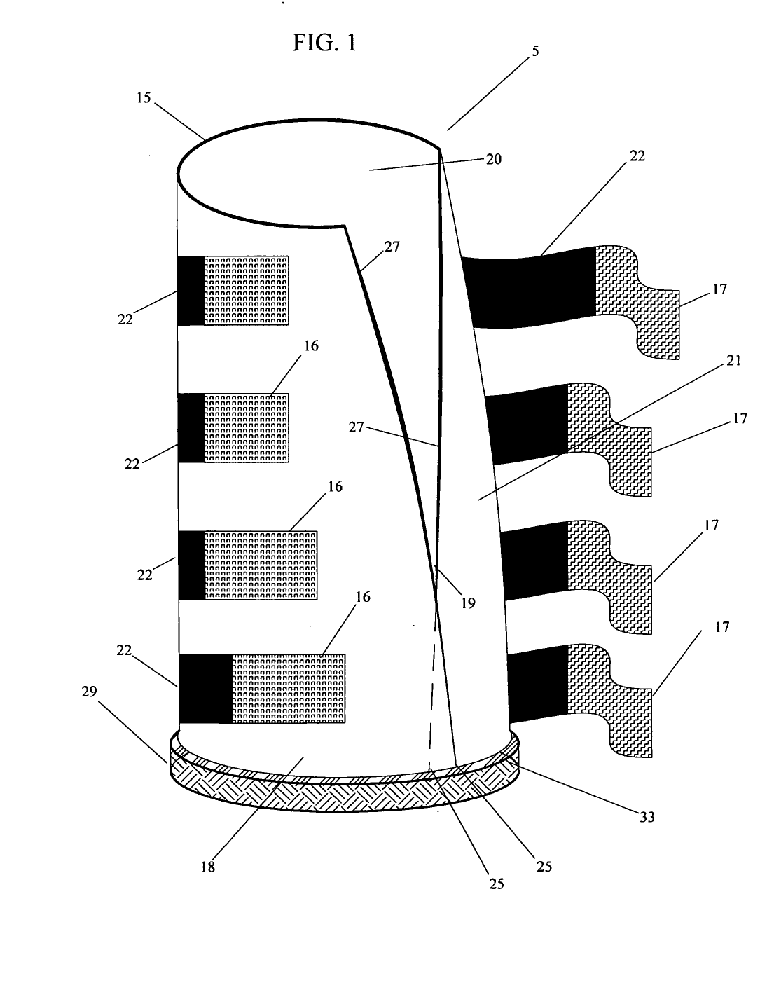

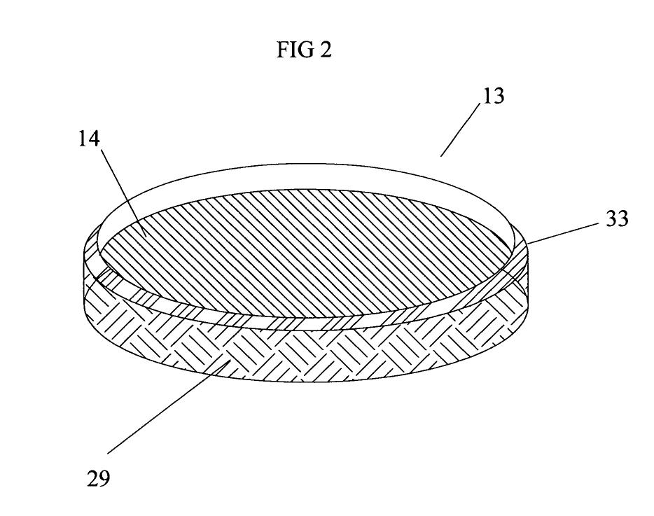

For the purpose of explaining how the protective device functions or operates, reference will be made to FIG. 1 and FIG. 2. FIG. 1 shows a hoof and limb protective device 5 for a horse. The protective device can be made in various sizes and has an adjustable means for wrapping the device around the limb of a horse and provides. The means for adjusting the device allows for the device to be deployed upon a variety of sized horses and a variety of any bandage, wrap, splint or cast that might be on the horse's limb. It should be pointed out that the device can come in various sizes depending on the type or size of animal.

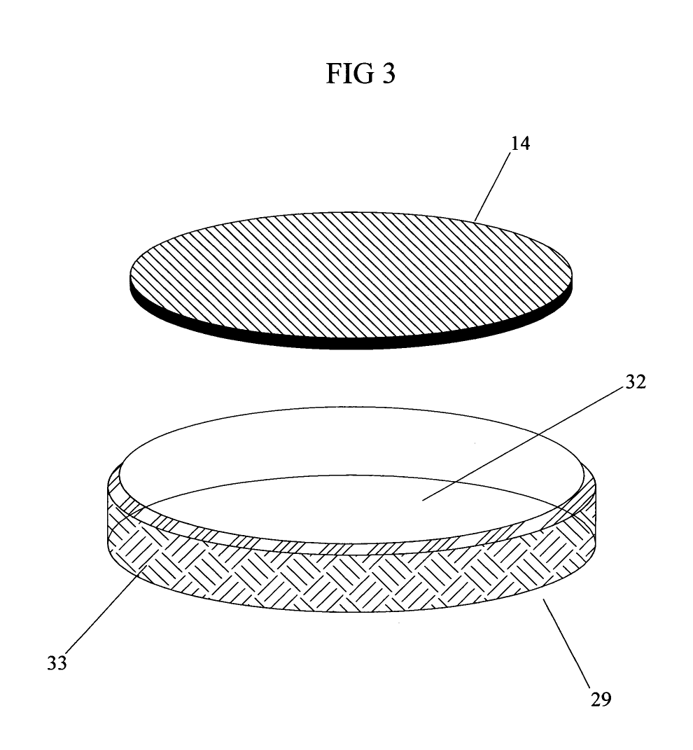

The device is constructed by using pliable and rugged materials for a sole 13 on the protective device. In the present invention, a piece of circular moldable leather 29 is used for the base 29 due to the tough pliable nature of the natural product. The moldable base 29 has a bottom side 31 (not shown) and a top side 32 with an edge 33 such that the edge is perpendicular to the bottom side, FIG. 3. In one embodiment, the leather of the sole is treated and conditioned to permit the manufacturer to imprint an impression upon the top side 32 of the base for size of horse's hoof or shoe. For example, the leather base 29 for a horse can be sized to accept a variety hoof or horseshoe sizes - to impart a base that improves stability and balance for an injured horse. The bottom side 31 of the leather is treated to be water resistant to permit contact with the ground. The treated leather is able to be cleaned with soap and water.

Attached to the upper end of the edge 33 is a trapezoidal shaped sheet of material called a shell 10. The bottom or longer side of the trapezoidal shaped shell is attached to the edge 33 of the base 29. The shell 10 is made of a tough, water resistant, and flexible material, like Kevlar®. The shell's bottom edge is attached to the upper edge of the base 29 and can be attached by sewing, stapling, gluing or using other methods known to those skilled in the art. When attaching the shell 10 to the edge 33, the ends of the trapezoidal base are overlapped slightly 25 to provide a barrier to external moisture and dirt.

By attaching the trapezoidal shaped shell 10 to the edge of the sole in the manner described above, a somewhat tubular shaped shell 10 is created, FIG. 1. The angled edges 27 of the trapezoidal shape are not closed when the shell's bottom edge is attached to the edge of the base creating an open axis 19 for the equine's limb to be inserted.

The shell's open axis 19 runs from a narrower upper end 15 to the point at which the angled edges 27 overlap. This opening provides an easier means for placing the horse's hoof inside the protective device prior to wrapping or closing up the shell around the horse's leg. The opening typically runs down the vertical axis of the protective device and would be placed such that the opening is on the back side of the horse's leg or hoof Other placements of the opening along an axis from the upper end to the lower end are possible as well.

The use of a material like Kevlar® for the shell 10 allows the user to clean the protective device with soap and water or just plain water. The flexibility of the shell material allows the material to be wrapped around the horse's lower leg. When a horse has any bandage, wrap, splint or cast placed upon the horse's lower leg, the wrapping of the shell around the bandage, wrap or cast can be sized or adjusted for the comfort of the animal, complete protection of bandage, wrap or cast, and durable for the environment of the animal.

In the present invention, the shell 10, which has an inside 20 and an outside 21, has several elastic straps 22 attached to the outside of the shell. The elastic straps have two ends with one end secured to the shell and the other end being free so the strap can be wrapped securely upon the shell and equine's limb, FIG. 1. In the present invention, the straps are attached such that the straps are placed perpendicular to the open axis 19 to allow for a more secure closure when the ends of the strap are attached. The ends of the elastic straps have hook 17 and loop 16 attachment material, like Velcro®, placed upon the straps permitting the user to enclose the shell around the horse's limb. When the elastic straps are wrapped and the ends are attached by the hook and loop material, the shell covers the horse's limb providing a barrier from the environs in which the horse or animal will roam.

The straps elasticity permits the user to adjust the protective device placed upon the animal depending on the size of any bandage, wrap, splint or cast placed upon the animal's leg. When an animal is injured and treated, it is not uncommon for a series of bandage, wraps, splints or casts—or a combination of the four—to be used upon the injured leg during a course of treatment; the present invention permits the user to employ the durable and comfortable protective device throughout the period the animal is being treated. The hook and loop material can be placed upon the elastic material in other manners to perform the same task as described previously. For example, one end of the elastic strap will be secured to the outer side of the shell in a substantially horizontal arrangement, FIG. 1. A loop buckle can be placed on the secured end and the free end of the strap can have the hook and loop material placed upon the elastic strap such that as the free end is pulled through and back over the strap, the hook and loop material will be positioned to attach. The purpose of the elastic straps allows the various sized limbs and treatment devices to be secured in place when the protector is placed upon the limb.

By using a tough, durable, and adjustable protective device over any bandage, wrap, splint or cast, the user is able to save a substantial amount of money by eliminating unnecessary changes to any bandages, wraps, splints or casts that need replacing due to exposure to the environs the animal will roam. By protecting the bandage, wrap, splint or cast from the natural environs of the animal, the bandage, wrap, splint or cast is able to last longer and be preserved—providing the horse with improved treatment and enhanced healing process during the course of recovery. Fewer replacements of bandages, wraps, splints, or casts can mean fewer visits to the specialist that treat animal injuries and result in lower costs to treat an animal's medical condition or injury.

In the present invention, a padding insert 14, FIG. 2 is placed upon the top of the moldable base. The padding insert 14 is made of a tough flexible material that is attached to the top of the base 29 and has the same general shape of the base but having slightly smaller dimensions. The padding insert 14 can be attached using several means known to those skilled in the art, in the present invention, the padding insert is glued to the top of the base. Other embodiments can be used to allow removal and replacement of the padding insert, including using hook and loop attachment material attached to the top of the base and complimentary hook and loop attachment material attached to the bottom of the padding insert 14. The padding insert can be removed and replaced with another padding insert that has hook and loop attachment material attached to the bottom of the padding insert.

By having a removable and replaceable padding inserts a variety of pad inserts can be used depending on the type of medical condition or injury that the animal has suffered. Additionally, the padding can be replaced when the padding has worn out and provide the user with a longer lasting hoof and limb protector. Other embodiment for attaching the padding insert include; gluing sewing, welding, riveting or other means known to those skilled in the art.

The padding insert 14 provides a platform for the animal to step on that is more comfortable than the sole. The padding insert, being flexible, provides additional stability for the animal to place weight upon the bottom of the animal's hoof or paw. In one embodiment, the base has an impression placed upon the top side and when the padding insert 14 is placed on top of the sole this allows the horse to place weight upon the bottom of the hoof allowing for a more even distribution of weight to the underside of the hoof. This distribution of the animal's weight is beneficial in that an animal that has an injured leg is reluctant or is pained when placing weight upon that hoof or leg. By providing a means for the animal to more evenly distribute their weight to the bottom side of the hoof or paw will allow the animal greater opportunities to move around.

The padding material needs to be waterproof and breathable due to a number of maladies that are associated with exposing a horse's hoof to an airtight moist environment. In the preferred embodiment neoprene has proven effective. The thickness of the padding can be adjusted depending on the type and size of the horse or the malady being treated.

In one embodiment of the device, a piece of elastic material, called a flap (not shown), is attached to the inner side of the shell 10 at the junction of the edge and the bottom of the opening 19 where the two edges of the bottom of the shell attaches to the sole. The flap, which attaches to the edge 33 of the moldable base 29, overlapping the angled edges of the trapezoidal shaped shell, provides a barrier to dirt, moisture or other debris that could enter into the interior of the protective covering when the device is placed upon an animal's limb. In the preferred embodiment, neoprene is used as the material for the flap. It is preferred that the material be flexible, elastic, durable and waterproof to eliminate dirt, debris or moisture from entering into the shell when the device is placed upon an animal.

In another embodiment (not shown), two pieces of padding material, called flap covers 23, are attached to the bottom edge of the shell and provide a similar function to the flap 24. The elastic flap covers are place at the base of the opening 19 of the shell 10 where the shell is sewn or attached to the edge of the moldable base. The barriers are strategically placed at the base of the shell opening to prevent moisture, dirt, or other items from penetrating into the interior of the shell when the protective device is placed upon the animal's leg. In this particular embodiment two rectangular pieces are sewn at the bottom of the angular edges of the shell and when the elastic straps 22 are closed around the animal's leg, the barriers are placed at the lowest point of the closed opening and provide additional means for repelling moisture, dirt or other items from penetrating the shell's interior when closed.

Another embodiment to improve the traction of the protective device is to attach a cleat type device to the bottom of the moldable base 29. Depending on the nature of the injury and the size and weight of the animal, cleats can be used to improve the traction of the horse's movement in the horse's environment.

I claim:

1. An equine limb protector for covering a bandage, splint, dressing or cast comprising: a substantially circular sole made up of a ground contacting base layer having an upper side, a lower side and an edge side, a padding insert attached to the upper side of the base layer with the base and padding insert sized slightly larger than an equine's hoof which is to be placed in the limb protector; a substantially trapezoidal shaped shell for covering the limb, bandage, splint, dressing or cast of the equine made from a tough, flexible, water resistant material, wherein a bottom edge of the trapezoidal shaped shell is attached to the upper edge side of the base creating a tubular like structure that is open at a top edge of the trapezoidal shape shell for an equine's limb to protrude there from, an opening from the bottom to the top of the trapezoidal shaped shell created by the angular edges of the trapezoidal shape shell coming together when the bottom edge of the shell is attached to the upper edge side of the base layer, wherein the opening allows for easier ingress and egress of the limb and hoof into and out of the protector device; two or more elastic straps, each strap having two sides and two ends, one end is attached to the tubular shell with an inner side of the strap attached to an outer surface of the tubular shell, the attached end is attached to the tubular shell substantially perpendicular to the opening, a piece of hook and loop attachment material placed on the outer side of the attached end; and a piece of compatible hook and loop material attached to the inner side of the other end of the strap which is free from the tubular shell, wherein said free end of the strap is drawn around a horse's limb and the hook and loop materials are attached securing the device around the equine's limb enclosing the limb within the shell.

2. The equine limb protector of claim 1 wherein the bottom edge of the trapezoidal shaped shell is attached to the upper edge side of the base layer such that the shell's angled edges overlap on the upper edge side of the base layer.

3. The equine limb protector of claim 1 further comprising a buckle loop placed on or near the attached end of the two or more straps and the hook and loop material placed on the free end of the strap, wherein the straps can be secured by pulling the strap through the buckle loop and pulling the strap through and back over the elastic strap to place the hook and loop material in a position to be secured together.

4. The equine limb protector of claim 1 wherein the tubular shell is made from a para-aramid synthetic fiber.

5. The equine limb protector of claim 1 wherein the lower side of the base layer is made from substantially water resistant leather.

6. The equine limb protector of claim 1 wherein the padding insert is made from neoprene.

7. The equine limb protector of claim 1 wherein the padding insert is attached to the upper side of the base layer by attaching hook and loop material to the upper side and compatible hook and loop material to an underside of the padded insert wherein the padded insert can be attached and removed from the upper side of the base layer by separating the hook and loop materials.

8. The equine limb protector of claim 1 wherein the upper side of the base layer is molded to conform to the shape of a hoof.

9. The equine limb protector of claim 1 wherein the upper side of the base layer is molded to conform to the shape of a horseshoe.

10. The equine limb protector of claim 1 wherein the padding insert is molded to conform to the shape of a hoof.

11. The equine limb protector of claim 1 wherein the padding insert is molded to conform to the shape of a horseshoe.

12. The equine limb protector of claim 1 further comprising one or more cleats attached to the lower side of the base layer.
